(19) United States
(12) Patent Application Publication
(10) Pub. No.: US 2003/0235373 A1
(43) Pub. Date: Dec. 25, 2003

(54) Multi-core ferrule and metallic die assembly for making the same

(75) Inventors: Kiyoshi Ishii, Ishikawa (JP); Kenichi Mitani, Tokyo (JP); Masumi Okajima, Tokyo (JP); Masafumi Okuma, Saitama (JP)

Correspondence Address: MARSHALL & MELHORN, LLC, Phillip S. Oberlin, Four SeaGate - 8th Floor, Toledo, OH, 43604, US

(73) Assignee: Kabushiki Kaisha Act One

(21) Appl. No.: 10/308,715

(22) Filed: Dec. 3, 2002

(30) Foreign Application Priority Data
Jun. 24, 2002 (JP) PATENT2002-182976

(51) Int. Cl. G02B 6/36

(52) U.S. Cl. 385/78

(57) ABSTRACT

In a multi-core ferrule for mounting two or more optical fiber cores, the core receiving bore is defined by a plurality of bore parts each having a circular cross section which are arranged in mutually parallel and contiguous relationship. Because the core receiving bore of this ferrule is formed by closely arranging a corresponding number of core receiving bore parts each having a circular cross section one next to another, the size of the outer diameter is minimized, and the ferrule is therefore adapted for a larger number of cores and a more compact design. Preferably, the bore parts communicate each with an adjacent one of the bore parts via a longitudinally extending narrow gap. The core pins for defining the core receiving bore are arranged in a mutually parallel and contiguous relationship so that they support each other against bending or other damages that could be caused by the pressure of the injected molding plastic material.

### TECHNICAL FIELD

The present invention relates to a multi-core ferrule for mounting two or more optical fiber cores and a metallic die assembly for manufacturing such a multi-core ferrule by injection molding, and in particular to a multi-core ferrule suitable for use in optical semiconductor modules and for butt joining a pair of optical fibers and a metallic die assembly for manufacturing such a multi-core ferrule.

### BACKGROUND OF THE INVENTION

A ferrule of this type, be it a single core type or a multiple core type, requires a high level of dimensional precision. In particular, the front end of the ferrule is required to have a highly precise outer diameter and a high level of coaxiality with respect to the axial center thereof. For this reason, zirconia is preferred as the material for such a ferrule. When making a ferrule out of zirconia, typically, a mixture of zirconia powder and plastic material is injection molded or press molded, and the molded product is sintered and finished by using abrasive material such as diamond or the like.

A zirconia ferrule is generally satisfactory in terms of performance such as dimensional precision, and can adequately meet the various requirements, but is not suitable for mass production and cost reduction because of the difficulty in manufacturing. Because a demand for ferrules is expected to rise sharply in the future, there is a growing desire to develop plastic ferrules so that they can be made by injection molding thermoplastic plastic material in a mass production process in an economical manner.

A plastic ferrule is suitable for mass production and cost reduction as compared to a zirconia ferrule because of ease in manufacturing, but is known to have problems in achieving a required level of performance such as dimensional precision because of the thermal shrinkage of the plastic material following the injection molding process which impairs the dimensional precision and coaxiality of the front end of the ferrule. Also, the core pin for forming the bore for receiving a fiber core is so thin that it is prone to breaking, bending or other damages due to the injection pressure of the plastic material.

To improve the dimensional precision which is the problem with such a plastic ferrule, Japanese patent laid open publication (kokai) No. 2000-84974 and Japanese patent laid open publication (kokai) No. 2001-96570 disclose a ferrule having a metallic insert pipe disposed around a front end thereof and extending at least up to a flange portion provided in an intermediate part thereof, the front end having a core wire receiving bore for receiving an extremely fine optical fiber core in an axial center thereof, and a method for making such a ferrule.

According to this prior art, the plastic ferrule is produced by placing an insert pipe having communication holes for passing plastic material therethrough in a part corresponding to a flange in a metallic die assembly, placing a core pin for forming a bore for receiving a core wire and a sheath at an end of an optical fiber in an axial center thereof, and injecting plastic material from a gate provided adjacent to the communication holes so that the plastic material is filled into the insert pipe from the communication holes and an entire ferrule including the flange is integrally molded by injection molding.

According to this plastic ferrule, the outer circumferential surface of the front part is given with a high level of circularity and coaxiality as well as a high level of outer dimensional precision owing to the use of an insert pipe in the injection molding process. Also, a precise alignment is achieved when connecting the ferrule to an opposing ferrule via a sleeve fitted onto the outer circumferential surface thereof, and a high precision in the positioning of an optical fiber core wire can be achieved when fitting the optical fiber core wire into the core wire receiving bore in the axial center. This contributes to the reduction in the transmission loss.

Various multi-core ferrules and methods for producing such ferrules have been proposed as can be found in Japanese patent No. 3,005,754 and Japanese patent laid open publication Nos. 2001-96570 and 2002-14254.

Optical communication is being extended to home uses, and an increase in the amount of data transmission and a more wide-spread use of two-way communication are expected to occur in the immediate future. This will trigger an increase in the demand for multi-core and more compact ferrules, and this will in turn require an increased level of precision in the manufacturing technology while enabling mass production and cost reduction at the same time. Use of zirconia for the ferrule according to the prior art prevents such mass production and cost reduction as it requires a highly complex manufacturing process.

For instance, if the prior art disclosed in Japanese patent laid open publications (kokai) Nos. 2000-84974 and 2001-96570 is directly applied to multi-core ferrules, because a plurality of core receiving bores for receiving a corresponding number of optical fiber cores are required to be arranged in parallel with each other in a mutually spaced relationship, there is a limit to compact design, and pursuing further development in multi-core and compact design may be prevented.

Because a plurality of core pins are required to be arranged in parallel relationship for forming a plurality of core receiving bores by the molding process, the core pins are more prone to breakage and bending than is the case with a single core pin. Also, when the core pins are not parallel to each other to a required precision, not only the dimensional precision is impaired but also the performance of the products varies from one unit to another. When a rigorous quality control is applied, the production efficiency will be impaired.

A SC type ferrule comprises a core receiving bore for receiving an optical fiber core in an axial center of a part ahead of a flange portion and an optical fiber sheath receiving bore in an axial center of a part behind the flange portion. When a SC type ferrule having such a structure is injection molded as a single piece, the molding cavity increases in size and the length of the path of the flow of the plastic molding material increases, and various problems in terms of cost and performance are produced as a result.

As the part ahead of the flange portion requires a high dimensional precision, it is preferably made of liquid crystal polymer which is relatively more expensive than other plastic materials. As the part behind the flange portion does not require so high a dimensional precision, it may be made of relatively inexpensive common plastic material. Therefore, making the entire ferrule in one piece out of the expensive liquid crystal polymer unnecessarily increases the manufacturing cost.

Increasing the length of the passage for the molding plastic material in the die assembly increases an unevenness of temperature in the molding plastic material and die assembly, and this in turn causes an unevenness in the fluidicity and thermal shrinkage of the plastic material, thereby impairing dimensional precision. In particular, the front end of the ferrule which corresponds to the front end of the flow of the molding plastic material contains a relatively large amount of slag, and this could cause flow marks and sink marks in this part, thereby causing a distortion of the inner circumferential surface of the core receiving bore. In particular, the coaxiality of the core receiving bore with respect to the insert pipe defining the outer diameter tends to be impaired.

In the case of the prior art disclosed in Japanese patent No. 3,005,754 and Japanese patent laid open publications Nos. 2001-356240 and 2002-14254, because a pair of core receiving bores for receiving a corresponding number of optical fiber cores are arranged in parallel with each other in a mutually spaced relationship, there is a limit to compact design, and pursuing further development in multi-core and compact design may be prevented.

Furthermore, according to the prior art disclosed in Japanese patent No. 3,005,754 and Japanese patent laid open publication No. 2001-356240, the ferrule is made either by forming a cylindrical sleeve by metallic injection molding process using ternary alloy, and press fitting a capillary formed by sintering zirconia powder into the cylindrical sleeve or by forming the entire ferrule by metallic injection molding process using ternary alloy. Therefore, a substantial amount of time and cost becomes necessary in the work of sintering, removing oil and grinding following the molding process, and the resulting ferrule is therefore substantially more expensive than a plastic ferrule.

According to the ferrule disclosed in Japanese patent laid open publication No. 2002-14254, because a molded plastic ferrule is fitted into a metallic sleeve, there are a number of problems that need to be addressed such as the breakage and bending of the core pin when forming the core receiving bore of the capillary by plastic molding, loss of dimensional precision owing to thermal shrinkage and difficulty in achieving the required dimensional precision and bonding strength in installing the separately prepared capillary into the metallic sleeve.

### BRIEF SUMMARY OF THE INVENTION

In view of such problems of the prior art, a primary object of the present invention is to provide a multi-core ferrule free from such problems of the prior art.

A second object of the present invention is to provide a multi-core ferrule which is suitable for compact design.

A third object of the present invention is to provide a multi-core ferrule which is easy and economical to manufacture.

A fourth object of the present invention is to provide a multi-core ferrule which can be manufactured at a high precision.

A fifth object of the present invention is to provide a metallic die assembly for injection molding such a multi-core ferrule.

According to the present invention, such objects can be accomplished by providing a multi-core ferrule, comprising: a ferrule main body including a cylindrical molded portion having a front end and a rear end, the molded portion defining an optical fiber receiving bore extending between the front end and rear end in an axial center thereof; the optical fiber receiving bore including a core receiving bore formed adjacent to the front end and a sheath receiving bore having a substantially larger inner diameter than the core receiving bore formed adjacent to the rear end, the core receiving bore being defined by a plurality of bore parts each having a circular cross section which are arranged in mutually parallel and contiguous relationship.

Because the core receiving bore of this ferrule is formed by closely arranging a corresponding number of core receiving bore parts each having a circular cross section one next to another, the size of the outer diameter of the ferrule main body is minimized, and the ferrule is therefore adapted for a larger number of cores and a more compact design. Preferably, the bore parts communicate each with an adjacent one of the bore parts via a longitudinally extending narrow gap although the presence of a thin wall of plastic material between the adjacent bore parts is consistent with the spirit of the present invention. Preferably, the optical fiber receiving bore further comprises a tapered bore which smoothly connects the core receiving bore with the sheath receiving bore.

An insert pipe may be insert molded onto an outer circumference of the cylindrical molded part so as to define an outer circumferential surface of the ferrule main body. The insert pipe is made of any hard material suitable for achieving a high dimensional precision of the outer circumferential such as stainless steel. The insert pipe may be provided with an engagement portion consisting of a recess or projection formed around a rear end of the insert pipe for the convenience of handling. Furthermore, when a base portion is insert molded onto the rear end of the ferrule main body to provide a SC type or other multi-core ferrule, the engagement portion provides a means for firmly attaching the ferrule main body to the base portion.

The insert pipe may comprise a thick walled portion surrounding the core receiving bore and a thin walled portion surrounding the sheath receiving bore so that the wall thickness of the molded portion can be made relatively uniform over its entire length. This minimizes the change in the cross sectional area of the passage for the injected plastic material, and this contributes to the production of a ferrule main body having a uniform quality and a high dimensional precision.

Preferably, a front end of the insert pipe comprises a reduced diameter portion having a reduced outer diameter, and the molded portion comprises a slag reservoir portion formed around the reduced diameter portion. According to such a multi-core ferrule, the slag contained in the front end of the flow of the molding plastic material is trapped in the reservoir defined around the reduced diameter portion so that the generation of flow marks and sink marks around the core receiving bore is avoided and the distortion of the inner circumferential surface of the core receiving bore is minimized.

The present invention also provides a metallic die assembly for injection molding a multi-core ferrule of this type, comprising: outer die assembly components defining a cylindrical cavity having a front end and a rear end for forming an outer circumferential surface of the ferrule main body; a plurality of first core pins slidably fitted into the cylindrical cavity in an axial center thereof from the front end thereof; and a second core pin slidably fitted into the cylindrical cavity in the axial center thereof from the rear end thereof; the first core pins being disposed in mutually parallel and contiguous relationship.

The second core pin may be provided with a tapered free end, and a recess provided in the tip of the tapered free end for receiving opposing ends of the first core pins so that the first core pins can be firmly supported by the second core pin and are thereby positively prevented from being bent, broken or otherwise damaged by the pressure of the molding plastic member.

According to a preferred embodiment of the present invention, the cylindrical cavity is adapted to receive an insert pipe defining an outer surface of the ferrule main body, and an end of the insert pipe corresponding to the front end of the cylindrical cavity comprises a reduced diameter portion having a reduced outer diameter, and a gate for injecting molding plastic material is provided in the rear end of the cylindrical cavity. Thereby, the front end of the molding plastic member which contains a relatively large amount of slag is trapped in a slag reservoir formed around the reduced diameter portion, and loss of dimensional precision and distortion of the molded portion can be minimized.

If the insert pipe comprises a thick walled portion surrounding the core receiving bore and a thin walled portion surrounding the sheath receiving bore, the wall thickness of the molded portion can be made substantially uniform over the entire length thereof. This is beneficial because a highly uniform flow of the molding plastic material can be achieved, and this contributes to a uniform property of the molded portion. Also, the uniform thickness also contributes to a favorable thermal shrinkage property which in turn provides a high dimensional precision and absence of distortions.

According to this metallic die assembly for making a multi-core ferrule of the present invention, because the passage for the molding plastic material is narrowed toward center in the tapered portion, the adjoining first core pins are urged by the molding plastic material toward each other and are thereby supported by each other so that the first core pins are effectively prevented from breaking or being bent by the injection pressure of the molding plastic material.

By defining the thick-walled portion cavity with a narrow passage defined between the inner circumferential surface of a front part of the insert pipe and the first core pins, the injection speed can be increased without increasing the injection pressure, and the first core pins are thereby prevented from being bent, broken or otherwise damaged by the injection pressure. Also, the temperature distribution of the metallic die assembly can be made uniform and the adverse effect of thermal shrinkage can be minimized.

### BRIEF DESCRIPTION OF THE DRAWINGS

Now the present invention is described in the following with reference to the appended drawings, in which:

FIG. 1 is a longitudinal sectional view of a multi-core ferrule embodying the present invention;

FIG. 2 is a longitudinal sectional view taken along line II-II of FIG. 1;

FIG. 3 is an end view as seen from the direction indicated by arrow III of FIG. 2;

FIG. 4 is a longitudinal sectional view of the multi-core ferrule attached to a mounting member;

FIG. 5 is an SC type ferrule embodying the present invention;

FIG. 6 is an end view as seen from the direction indicated by arrow VI of FIG. 5;

FIGS. 7a and 7b are a longitudinal sectional view and an end view of a modified embodiment of the insert pipe;

FIGS. 8a and 8b are a longitudinal sectional view and an end view of another modified embodiment of the insert pipe;

FIGS. 9a and 9b are a longitudinal sectional view and an end view of yet another modified embodiment of the insert pipe;

FIG. 10 is a fragmentary vertical sectional view of the metallic die assembly for injection molding the ferrule main body 1 illustrated in FIG. 1.

FIG. 11 is an enlarged fragmentary vertical sectional view of a part of the die assembly illustrated in FIG. 10;

FIG. 12 is an exploded perspective view showing the first core pins which are components of the metallic die assembly illustrated in FIGS. 10 and 11 to illustrate how they are mounted to the pin holder;

FIG. 13 is a longitudinal sectional view of another embodiment of the multi-core ferrule according to the present invention;

FIG. 14 is a longitudinal sectional view taken along line XIV-XIV of FIG. 13;

FIG. 15 is an end view as seen from the direction indicated by arrow XV of FIG. 14;

FIG. 16 is a longitudinal sectional view of yet another embodiment of the multi-core ferrule according to the present invention;

FIG. 17 is a longitudinal sectional view taken along line XVII-XVII of FIG. 16;

FIG. 18 is an end view as seen from the direction indicated by arrow XVIII of FIG. 17; and

FIGS. 19 to 21 are end views showing other modified embodiment of the arrangement of the core receiving bore parts.

### DETAILED DESCRIPTION OF THE PREFERRED EMBODIMENTS

The multi-core ferrule and method of making the same according to the present invention are described in the following in terms of concrete embodiments illustrated in the appended drawings. Referring to FIGS. 1 to 3, a ferrule is formed by a ferrule main body 1 by itself, and comprises an inner tube consisting of a molded portion 2 for receiving an optical fiber in an axial center thereof, and an outer tube consisting of an insert pipe 3 for defining the outer diameter of the ferrule main body 1. The inner and outer tubes are integrally joined to each other by placing the insert pipe 3 in a metallic die assembly and injection molding the molded portion 2 therein as will be described hereinafter. In the illustrated embodiment, the insert pipe 3 is not provided with any communication holes, but, if desired, may also be provided with communication holes as disclosed in Japanese patent laid open publication (kokai) No. 2000-84974 and Japanese patent laid open publication (kokai) No. 2001-96570.

The molded portion 2 is axially centrally provided with a core receiving bore 4a in a front end thereof for receiving the core of an optical fiber, a sheath receiving bore 4c in a rear end thereof for receiving the sheath of the optical fiber, and a tapered bore 4b communicating the core receiving bore 4a and sheath receiving bore 4c with each other. The tapered bore 4b provides a smooth transition between the core receiving bore 4a and sheath receiving bore 4c. The core receiving bore 4a, sheath receiving bore 4c and tapered bore 4b jointly form an optical fiber receiving bore 4.

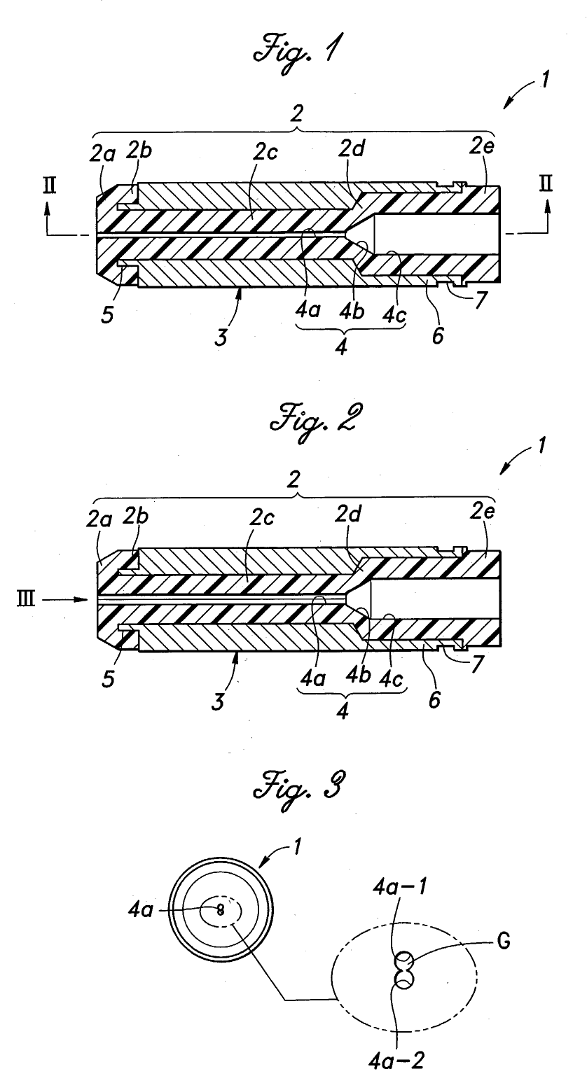

The core receiving bore 4a of the fiber receiving bore 4 is adapted to receive two or more cores of an optical fiber which are arranged in parallel with each other. In the embodiment illustrated in FIGS. 1 to 3, the core receiving bore 4a comprises a pair of adjoining core receiving bore parts 4a-1 and 4a-2, each having a substantially circular cross section, so as to be compatible with a two-core optical fiber. These two bore parts 4a-1 and 4a-2 are arranged in a both parallel and contiguous relationship. Preferably, the two bore parts 4a-1 and 4a-2 communicate with each other via a longitudinally extending narrow gap G (FIG. 3).

As the core receiving bore 4a is defined by a pair of adjoining or contiguous cylindrical spaces each having a circular cross section, the outer diameter of the ferrule is minimized so that the ferrule may be made suitable for even more compact design and a larger numbers of cores. Also, during the injection molding process, the extremely fine core pins for forming the core receiving bore are prevented from being bent or broken by the pressure of the injected plastic molding material as they are arranged one next to the other so as to support each other.

The molded portion 2 is formed by injection molding plastic material which is selected from various thermoplastic materials and provided with desired mechanical strength and dimensional precision. In particular, liquid crystal polymers are preferred among other engineering plastic materials as they are favorable in terms of mechanical strength and dimensional stability, and are suited for machining.

The insert pipe 3 comprises a relative thick-walled main portion, a reduced diameter portion 5 having a reduced outer diameter in a front end thereof, a thin-walled portion 6 having an enlarged inner diameter which is enlarged from the inner diameter of the remaining part of the insert pipe 3 in a front end thereof and an engagement portion 7 provided on the outer circumferential surface of the rear end of the thin-walled portion 6. The core receiving bore 4a having a uniform and small diameter extends across the thick-walled main portion and reduced diameter portion 5. The thick-walled main portion and thin-walled portion 6 have a uniform outer diameter. The tapered bore 4b corresponds to the transition between the thick-walled main portion and thin-walled portion 6. In the embodiment illustrated in FIGS. 1 to 3, the engagement portion 7 consists of an annular groove formed around the outer circumferential surface of the rear end of the thin-walled portion 6 of the insert pipe 3.

The molded portion 2 comprises a tapered tip portion 2a formed on the front end of the reduced diameter portion 5, a slag reservoir 2b formed around the outer circumferential surface of the reduced diameter portion 5, a small diameter cylindrical portion 2c defining the core wire receiving bore 4b in the axial center thereof inside the thick-walled main portion of the insert pipe 3, a tapered portion 2d provided inside the transitional part between the thick-walled main portion and thin-walled portion 6 of the insert pipe 2, and a large diameter cylindrical portion 2e defining the sheath receiving bore 4c in the axial center thereof inside the inner circumference of the thin-walled portion 6.

The insert pipe 3 allows the dimensional precision of the outer diameter and circularity of the assembly to be increased by being fitted on the outer circumferential surface of the molded portion 2, and the bonding strength between the molded portion 2 and the insert pipe 3 is reinforced by the reduced diameter portion 5 being embedded between the outer and inner parts of the tapered tip portion 2a of the molded portion 2. Also, the slag reservoir 2b for the molding plastic material is provided around the reduced diameter portion 5 so that the dimensional precision of the inner diameter of the core receiving bore 4a is improved as will be described hereinafter.

The molded portion 2 surrounding the sheath receiving bore 4c and tapered bore 4b is provided with a substantially uniform thickness with the aid of the thin-walled portion 6 on the rear part of the insert pipe 3. The engagement portion 7 formed around the rear end of the insert pipe 3 is useful both when using the ferrule main body 1 as an optical semiconductor module as it is, when manufacturing ferrules for butt connection, and when using the ferrule main body as a part of SC type or ST type ferrules.

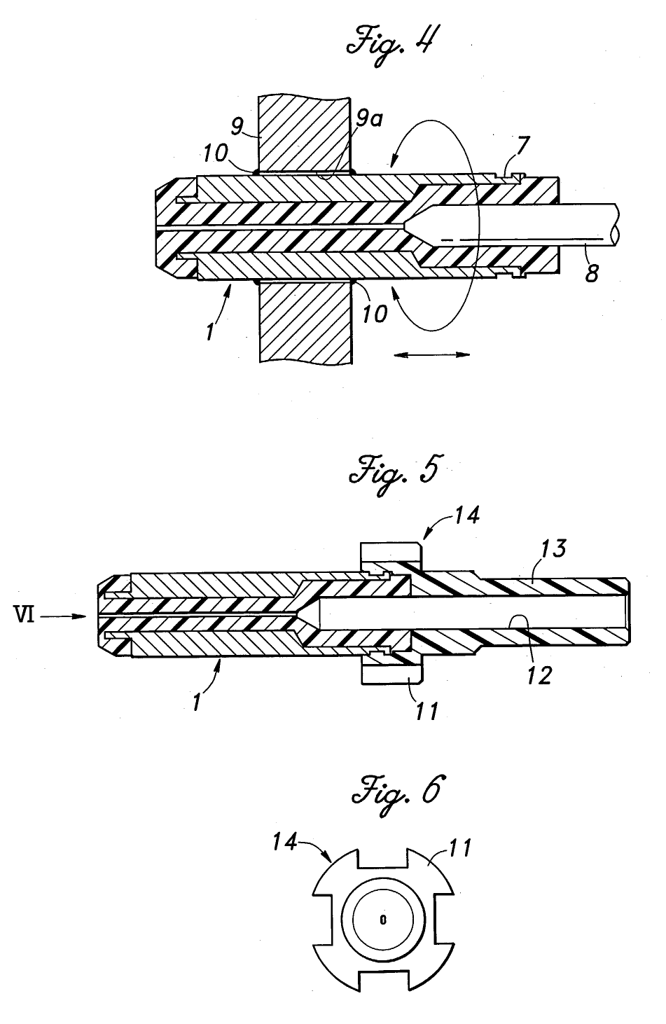

Referring to FIG. 4, for instance, a ferrule main body 1 having an optical fiber 8 mounted thereto may be passed through a mounting hole 9a of a mounting member 9 of an optical semiconductor module, and the ferrule main body 1 may be turned and moved axially with respect to the optical lens system (not shown in the drawing) of the optical semiconductor module so as to adjust the optical center line before the ferrule main body 1 is integrally and permanently attached to the mounting member 9.

The ferrule main body 1 can be held as desired by gripping the engagement portion 7 with a manipulator or the like when aligning the optical center line of the ferrule main body 1. The ferrule main body 1 can be integrally attached to the mounting member 9 either by welding or by using a bonding agent following the alignment and positioning of the optical axial line. In particular, when the insert pipe 3 is made of metallic material such as stainless steel, the insert pipe 3 can be integrally attached to a mounting member 9 by laser welding or the like as denoted by numeral 10.

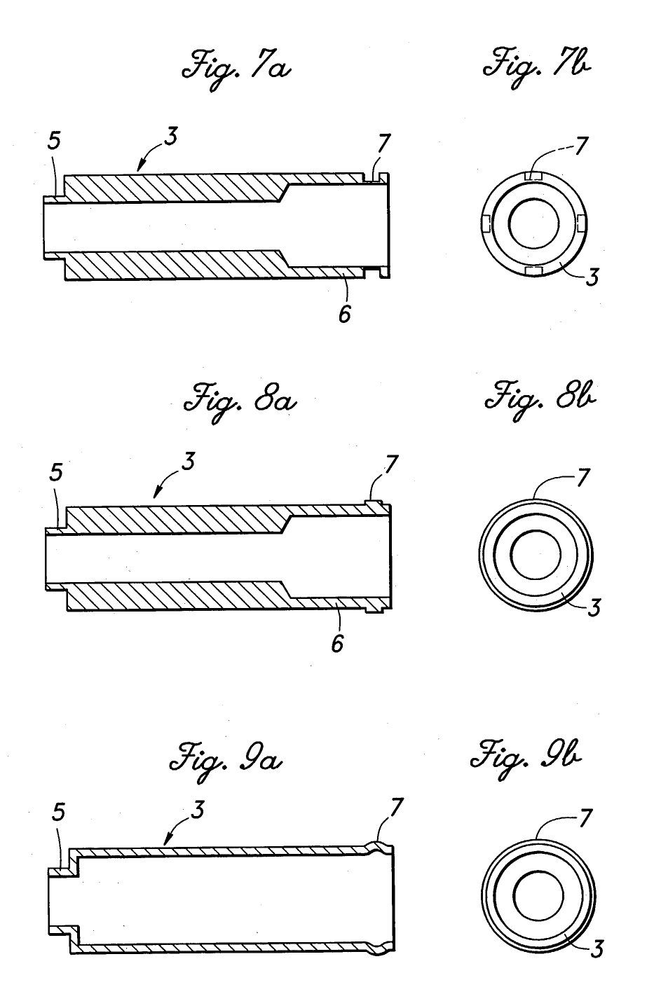

Referring to FIGS. 5 and 6, a SC type ferrule 14 can be produced by using the ferrule main body 1 as an insert component and injection molding a base portion 13 thereon, the base portion 13 comprising a flange portion 11 and a communication hole 12 communicating with the sheath receiving bore 4c in an axial center of the ferrule main body 1. A ST type ferrule (not shown in the drawing) can also be similarly manufactured by using the ferrule main body 1 as an insert component.

When producing a SC type or ST type in this manner, the engagement portion 7 ensures a strong attachment between the ferrule main body 1 and base portion 13 by providing a means for holding them together. The base portion 13 can be injection molded economically by using relatively inexpensive common engineering plastic material such as polybutylene terephthalate.

When the ferrule is adapted for optical semiconductor modules, butt connectors for optical fibers and ferrules of other types, the cost of each ferrule main body can be reduced through mass production, and other advantages such as ease of procurement and stocking can be achieved.

The insert pipe 3 may be made of such materials as hard metals such as stainless steel, titanium and fiber reinforced metals (FRM), ceramics such as zirconia, and high performance engineering plastics such as polyimide resin. In particular, a metallic pipe is desirable as it can be laser welded when used in a module, and stainless steel is highly desirable in view of its cost, heat resistance, rigidity and dimensional precision.

In the embodiment illustrated in FIGS. 1 to 3, the insert pipe 3 consisted of a relatively thick-walled metallic pipe. When it is made of stainless steel, forming the reduced diameter portion 5 and thin-walled portion 6 can be accomplished by machining of the outer circumferential surface of the front end, enlarging the inner circumferential surface of the rear end in both economically and at high precision.

It is also possible to form the insert pipe 3 by using a thin walled pipe member and press form the same in such a manner that a reduced diameter portion 5 is formed at the front end and an annular engagement portion 7 is formed by bulging out the outer circumferential surface of the rear end of the insert pipe 3 while doing away with the variations in the wall thickness as illustrated in FIGS. 9a and 9b.

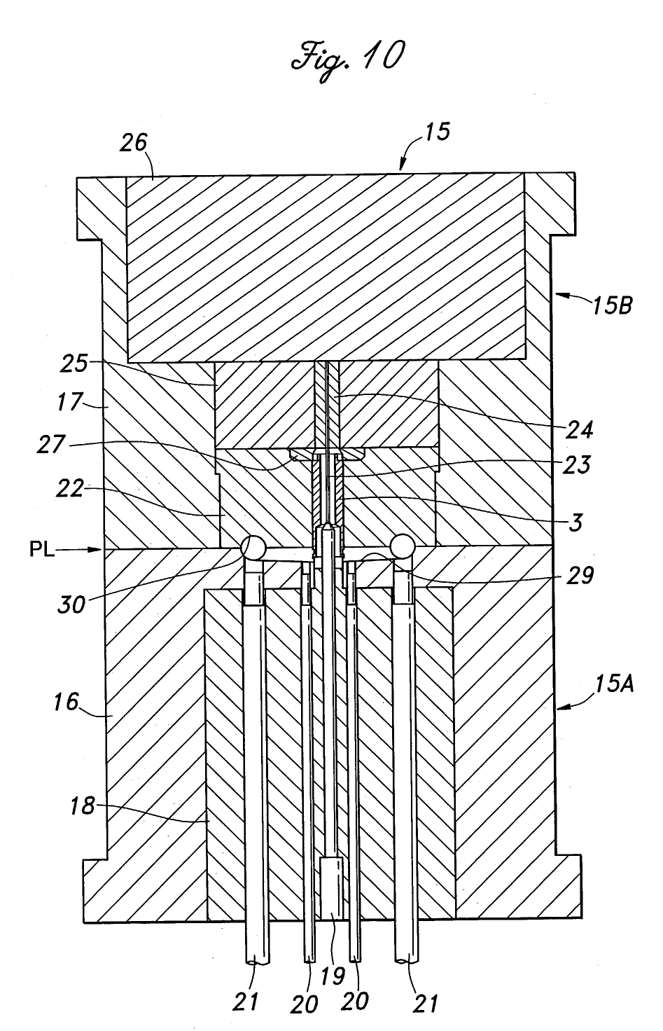

The insert pipe 3 may be provided with the engagement portion 7 by forming localized recesses on the outer circumferential surface of the insert pipe 3 as denoted by numeral 7 in FIGS. 7a and 7b, by providing an annular projection on the outer circumferential surface of the insert pipe 3 as denoted by numeral 7 in FIGS. 8a and 8b, or by forming localized projections (not shown in the drawings).

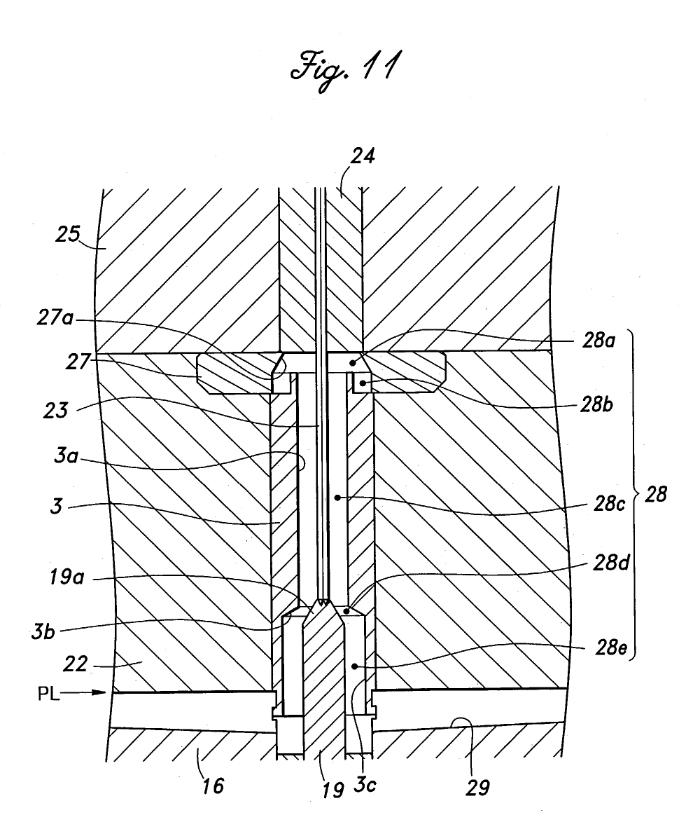

The method of manufacturing the ferrule main body 1 is described with reference to FIGS. 10 to 12. FIG. 10 shows a metallic die assembly for injection molding, which comprises a moveable metallic die component 15A and fixed metallic die component 15B opposing each other on either side of a parting line PL. The moveable metallic die component 15A comprises a movable die plate 16, and the fixed metallic die component 15A comprises a fixed die plate 17.

The movable die plate 16 is incorporated with a moveable core 18 which is in turn centrally provided with a second core pin 19 for forming the tapered bore 4b and sheath receiving bore 4c of the ferrule main body 1. A pair of ejector pins 20 and 21 are provided on either side of the second core pin 19 for pushing out the molded product or the ferrule main body 1.

The fixed metallic die component 15B is provided with a lower core 22 for receiving the insert pipe 3 and an upper core 25 fitted with a pin holder 24 supporting a pair of first core pins 23 for forming the core receiving bore 4a of the ferrule main body 1, and a holding block 26 for holding the upper core 25 from above.

The first core pins 23 are extremely fine pins made of cemented carbide. The upper ends or base ends of the first core pins 23 are supported by the pin holder 24 while the lower ends or free ends thereof consisting of pointed ends 23a (FIG. 12) are supported by being detachably fitted into a slot formed in the upper end of the fixed lower core 22. The pin holder 24 is engaged by the upper surface of a cavity block 27 mounted to the fixed lower core 22, and is thereby fixedly secured.

The pin holder 24 is provided with a mounting hole 24a consisting of a pair of mutually adjoining holes each having a circular cross section for receiving the first core pins 23 adapted to form the core receiving bore 4a in an axial center thereof. As the inner diameter of the mounting hole 24a is required to have a high dimensional precision, it is desirable to achieve the required dimension by applying electroplating to the surface of the base material and perform electroforming thereon. To minimize the shrinkage of the molded product or prevent the generation of sink marks, highly thermally conductive nickel or nickel alloy which also provides a high hardness may be electrodeposited onto base material also having a high thermal conductivity such as copper.

The first core pins 13 are fitted into the mounting hole 24a, and are fixedly secured therein by applying an epoxy or other two-part bonding agent from above. The first core pins 13 are thereby bonded not only to the mounting hole 24 but also to each other via their contact surfaces. If there is any excess bonding agent on a surface other than the contact surfaces, it should be wiped off.

The first core pins 13 are required to be integrally attached to the mounting hole 24a, but may not be necessarily attached to each other. It is preferable, however, to attach them to each other in terms of mechanical strength, but they may be simply placed closely to each other in a mutually parallel relationship. Other bonding means such as welding may also be used instead of a bonding agent.

The cavity block 27 which prevents the pin holder 24 received in the fixed upper core 25 from coming off is formed with an inner bore 27a for defining a tapered tip cavity 28a for forming the tapered tip 2a of the molded portion 2 and a reservoir cavity 28b for forming the slag reservoir 2b.

In a front part of the interior of the insert pipe 3, a thick-walled portion cavity 28c for forming the small diameter cylindrical portion 2c of the molded portion 2 is defined between the inner circumferential surface 3a of the thick-walled main portion of the insert pipe 3 and the first core pins 23. In a rear part of the interior of the insert pipe 3, a large diameter portion cavity 28e for forming the large diameter cylindrical portion 2e of the molded portion 2 is defined between the inner circumferential surface 3c of the thin-walled portion 6 of the insert pipe 3 and the second core pin 19. In an intermediate part of the interior of the insert pipe 3, a tapered portion cavity 28d is defined between the inner circumferential surface 3b of the tapered portion of the insert pipe 3 and the tip 19a of the second core pin 19.

Thus, a cavity 28 for injection molding the molded portion 2 comprised of the tapered tip cavity 28a, reservoir cavity 28b, thick-walled portion cavity 28c, tapered portion cavity 28d and large diameter portion cavity 28e is formed by closing the metallic die assembly 15 for the injection molding process.

To the large diameter portion cavity 28e of the cavity 28 are connected a plurality (four, for instance) of gates 29 extending radially along the parting line PL of the metallic die assembly. Each gate 29 communicates with a spool (not shown in the drawing) provided above the fixed metallic die component 15B via an annular runner 30 so that the molding plastic material injected from the spool may be filled into the cavity 28 and the molded portion 2 of the ferrule main body 1 may be injection molded.

The molding plastic material first flows into the large diameter portion cavity 28c, and then flows into the thick-walled portion cavity 28c via the tapered portion cavity 28d which narrows the flow of the molding plastic material radially inwardly. (The wall thickness of the molded portion is substantially uniform over its entire length, but the molded portion corresponding to the large diameter portion cavity 28e has a somewhat larger cross sectional area than that corresponding to the thick-walled portion cavity 28c owing to the difference in the average diameter.) Thereafter, the molding plastic material flows towards the front end through the narrow passage (thick-walled portion cavity 28c) defined between the small diameter inner circumferential surface 3a and the first core pins 23, and eventually reaches the reservoir cavity 28b after passing through the tapered tip cavity 28a and around the tip of the reduced diameter portion 5.

According to this process of injection molding, the first core pins 23 for forming the core receiving bore 4a for a two-core optical fiber are prevented from being bent or broken due to the injection pressure of the molding plastic material by being supported by each other as the adjoining first core pins are disposed in parallel to each other in contact with each other at their opposing surfaces.

Because the molding plastic material flowing into the thick-walled portion cavity 28c is narrowed in cross section radially inwardly by the tapered portion cavity 28d, the flow of the molding plastic material urges the first core pins 23 toward each other so that the first core pins 23 are prevented from being bent or broken due to the injection pressure of the molding plastic material.

Also, because the insert pipe 3 surrounding the first core pins 23 is provided with a large wall thickness and the thick-walled portion cavity 28c is formed by the narrow passage defined between the small diameter inner circumferential surface 3a and first core pins 23, the injection speed can be increased without increasing the injection pressure, and this prevents the bending, curving or otherwise damaging the first core pins 13. This also contributes to making the temperature distribution in the metallic die assembly more uniform, and thereby minimizing the adverse effect of thermal shrinkage.

At the front end of the reduced diameter portion 5, the flow of the plastic material passes around it and reaches the reservoir cavity 28b on the outer circumference of the assembly remote from the axial center where the core receiving bore 4a is located. Therefore, the part of the molding plastic material at the front end of the flow which contains a relatively large amount of slag is trapped in the reservoir cavity 28b so that the generation of flow marks and sink marks around the core receiving bore 4a is avoided and the distortion of the inner circumferential surface of the core receiving bore 4a is minimized.

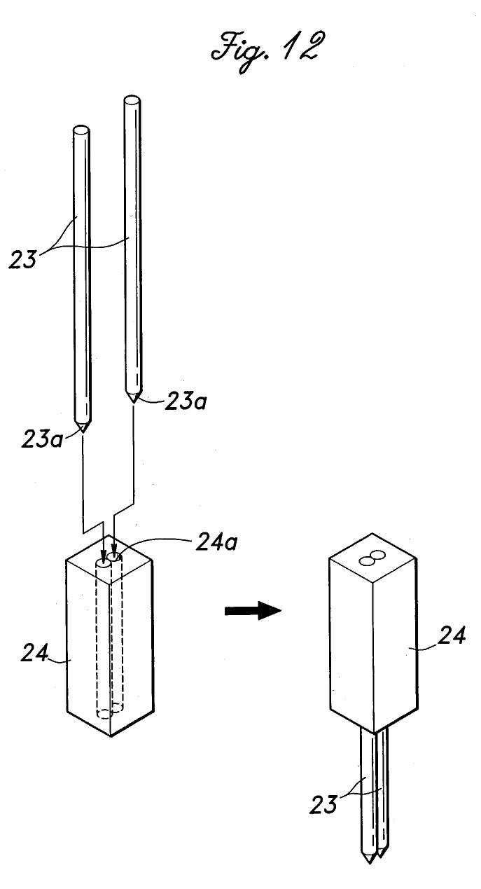

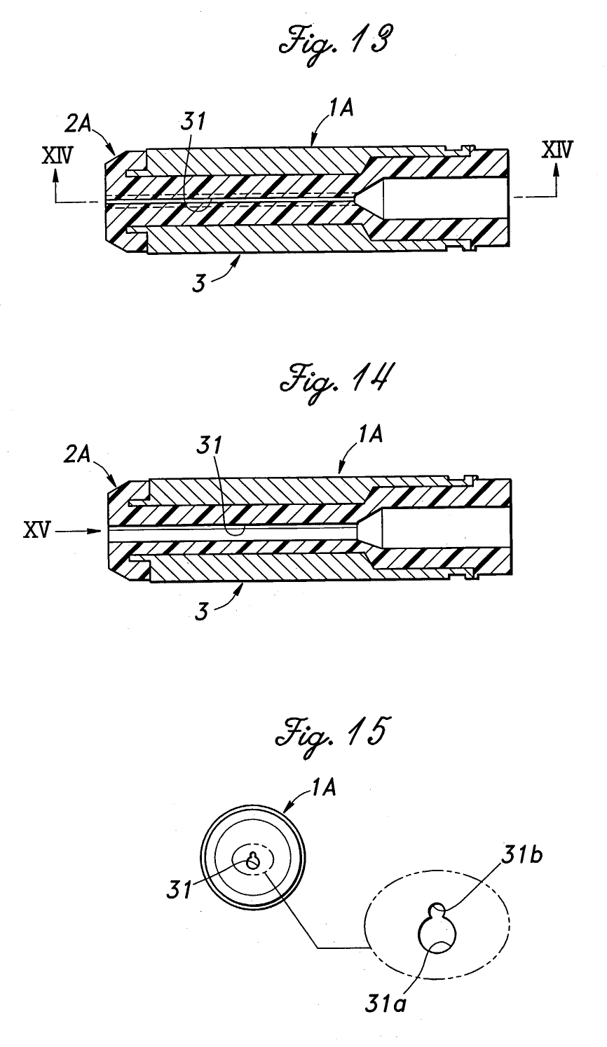

FIGS. 13 to 15 show a modified embodiments of the multi-core ferrule. Whereas the core receiving bore 4a in the two-core ferrule main body 1 in the preceding embodiment consisted of a pair of core receiving bore parts 4a-1 and 4a-2 having an identical diameter disposed one next to the other, the core receiving bore 31 of the two-core ferrule main body 1A illustrated in FIGS. 13 to 15 comprises a pair of core receiving bore parts 31a and 31b having different diameters disposed one next to the other. The embodiment illustrated in FIGS. 16 to 18 show a three-core ferrule main body 1B wherein the core receiving bore 32 is defined by three core receiving bore parts 32a, 32b and 32c of an identical diameter disposed one next to the other along a straight line.

These ferrules 1A and 1B can be injection molded in a similar fashion as the ferrule main body 1 of the previous embodiment simply by changing the shape and number of the first core pins 23 mounted to the holder 24, and changing the shape of the receiving slot formed in the front end of the second core pin 19, and provide similar advantages.

The present invention is by no means limited to these embodiments, but may include any other embodiments in which a plurality of circular core receiving bore parts are placed one next to another to jointly define a core receiving bore. This can be accomplished by using a plurality of first core pins adapted for the desired core receiving bore which are disposed so as to support each other by being in mutual contact at their opposing surfaces.

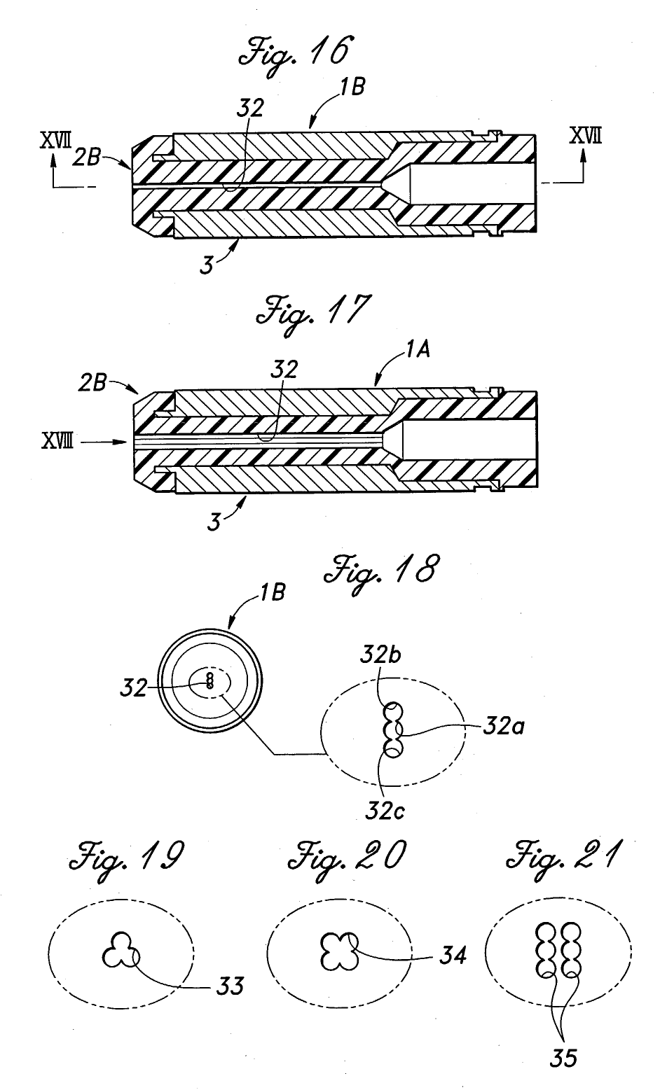

For instance, the core receiving bore parts may be arranged radially at the interval of 120 degrees around the axial center line to define a core receiving bore 33 of a three-core ferrule as illustrated in FIG. 19. Also, the core receiving bore parts may be arranged radially at the interval of 90 degrees around the axial center line to define a core receiving bore 34 in the case of a four-core ferrule as illustrated in FIG. 20. In the example illustrated in FIG. 21, six core receiving bore parts each having an identical circular cross section are arranged along a pair of straight lines to define a pair of core receiving bores 35 each consisting of three of the core receiving bore parts arranged along a straight line.

Although the present invention has been described in terms of preferred embodiments thereof, it is obvious to a person skilled in the art that various alterations and modifications are possible without departing from the scope of the present invention which is set forth in the appended claims.

1. A multi-core ferrule, comprising:
a ferrule main body including a cylindrical molded portion having a front end and a rear end, said molded portion defining an optical fiber receiving bore extending between said front end and rear end in an axial center thereof;
said optical fiber receiving bore including a core receiving bore formed adjacent to said front end and a sheath receiving bore having a substantially larger inner diameter than said core receiving bore formed adjacent to said rear end, said core receiving bore being defined by a plurality of bore parts each having a circular cross section which are arranged in mutually parallel and contiguous relationship.

2. A multi-core ferrule according to claim 1, wherein said bore parts communicate each with an adjacent one of said bore parts via a longitudinally extending narrow gap.

3. A multi-core ferrule according to claim 1, wherein said optical fiber receiving bore further comprises a tapered bore which smoothly connects said core receiving bore with said sheath receiving bore.

4. A multi-core ferrule according to claim 1, further comprising an insert pipe which is insert molded onto an outer circumference of said cylindrical molded part so as to define an outer circumferential surface of said ferrule main body.

5. A multi-core ferrule according to claim 4, wherein said insert pipe comprises a thick walled portion surrounding said core receiving bore and a thin walled portion surrounding said sheath receiving bore.

6. A multi-core ferrule according to claim 4, wherein a front end of said insert pipe comprises a reduced diameter portion having a reduced outer diameter, and said molded portion comprises a slag reservoir portion formed around said reduced diameter portion.

7. A multi-core ferrule according to claim 4, wherein a rear end of said insert pipe is provided with an engagement portion consisting of a projection on an outer surface thereof.

8. A multi-core ferrule according to claim 4, wherein a rear end of said insert pipe is provided with an engagement portion consisting of a recess on an outer surface thereof.

9. A multi-core ferrule according to claim 1, further comprising a substantially cylindrical base portion injection molded onto a rear end of said ferrule main body, the base portion defining a sheath receiving bore aligned with said sheath receiving bore of said ferrule main body.

10. A die assembly for injection molding a multi-core ferrule according to claim 1, comprising:
outer die assembly components defining a cylindrical cavity having a front end and a rear end for forming an outer circumferential surface of said ferrule main body;
a plurality-of first core pins slidably fitted into said cylindrical cavity in an axial center thereof from said front end thereof; and
a second core pin slidably fitted into said cylindrical cavity in the axial center thereof from said rear end thereof;
said first core pins being disposed in mutually parallel and contiguous relationship.

11. A die assembly according to claim 10, wherein said second core pin is provided with a tapered free end, and a recess provided in the tip of said tapered free end for receiving opposing ends of said first core pins.

12. A die assembly according to claim 10, wherein said cylindrical cavity is adapted to receive an insert pipe defining an outer surface of said ferrule main body.

13. A die assembly according to claim 12, wherein an end of said insert pipe corresponding to said front end of said cylindrical cavity comprises a reduced diameter portion having a reduced outer diameter, and a gate for injecting molding plastic material is provided in said rear end of said cylindrical cavity.

14. A die assembly according to claim 12, wherein said insert pipe comprises a thick walled portion surrounding said core receiving bore and a thin walled portion surrounding said sheath receiving bore.

15. A die assembly according to claim 14, wherein a front end of said insert pipe comprises a reduced diameter portion having a reduced-outer diameter, and said cylindrical cavity comprises a reservoir cavity surrounding said reduced diameter portion.
